(19) United States
(12) Patent Application Publication
(10) Pub. No.: US 2014/0095822 A1
(43) Pub. Date: Apr. 3, 2014

(54) SECURE REMOVABLE MASS STORAGE DEVICES

(71) Applicant: TREND MICRO INCORPORATED, Tokyo (JP)

(72) Inventors: Tomoyuki SHIGA, Tokyo (JP); Taichi EJIRI, Tokyo (JP); Xiao LIU, Tokyo (JP); Huang Chih JUNG, Tokyo (JP)

(73) Assignee: TREND MICRO INCORPORATED, Tokyo (JP)

(21) Appl. No.: 13/632,309

(22) Filed: Oct. 1, 2012

(51) Int. Cl. G06F 12/14

(52) U.S. Cl. 711/163; 711/E12.098

(57) ABSTRACT

A removable mass storage device includes a controller and a memory storage area. A secured portion of the memory storage area may be a permanently write-protected portion. Programs provided by the operating system, e.g., application programming interface (API), for accessing the memory storage area cannot disable the write-protection of the permanently write-protected portion, preventing them from writing to the permanently write-protected portion. The controller does not enforce the write-protection against a security command of a secure library, allowing writing to the permanently write-protected portion using the security command. The security command may be issued by an API of the secure library. The secured portion of the memory storage area may also be a hidden portion that is not visible to the operating system, but is accessible by way of the secure library.

### BACKGROUND OF THE INVENTION

1. Field of the Invention

The present invention relates generally to computer security, and more particularly but not exclusively to methods and apparatus for securing removable mass storage devices.

2. Description of the Background Art

Removable mass storage devices are portable, allowing a user to carry large amounts of data in his person at all times. And because they are removable, these devices are not tied down to a particular computer, but may be moved from one computer to another. A popular removable mass storage device is the universal serial bus (USB) memory device that is accessible over a USB interface (e.g., a USB port).

USB memory devices may be write-protected to prevent erasures of or writing to data stored therein. The write-protection may be disabled to allow writing, but this may compromise the integrity of stored data. The write-protection may also be used by an operating system for general access control, which may interfere with legitimate operations that involve writing to the USB memory device. A USB memory device may also suffer from throughput problems when more than one program tries to access the device.

### SUMMARY

In one embodiment, a removable mass storage device includes a controller and a memory storage area. A secured portion of the memory storage area may be a permanently write-protected portion. Programs provided by the operating system, e.g., application programming interface (API), for accessing the memory storage area cannot disable the write-protection of the permanently write-protected portion, preventing them from writing to the permanently write-protected portion. The controller does not enforce the write-protection against a security command of a secure library, allowing writing to the permanently write-protected portion using the security command. The security command may be issued by an API of the secure library. The secured portion of the memory storage area may also be a hidden portion that is not visible to the operating system, but is accessible by way of the secure library.

These and other features of the present invention will be readily apparent to persons of ordinary skill in the art upon reading the entirety of this disclosure, which includes the accompanying drawings and claims.

### DESCRIPTION OF THE DRAWINGS

FIG. 1 shows a schematic diagram of a computer in accordance with an embodiment of the present invention.

FIG. 2 schematically shows an example partition layout of a memory storage area of a universal serial bus (USB) memory device in accordance with an embodiment of the present invention.

FIG. 3 schematically shows an example partition layout of a memory storage area of a USB memory device in accordance with another embodiment of the present invention.

FIG. 4 schematically shows an example partition layout of a memory storage area of a USB memory device in accordance with yet another embodiment of the present invention.

FIG. 5 shows a flow diagram schematically illustrating a method of accessing a memory storage area of a USB memory device in accordance with an embodiment of the present invention.

FIG. 6 shows a flow diagram schematically illustrating a method of accessing a memory storage area of a USB memory device in accordance with another embodiment of the present invention.

The use of the same reference label in different drawings indicates the same or like components.

### DETAILED DESCRIPTION

In the present disclosure, numerous specific details are provided, such as examples of apparatus, components, and methods, to provide a thorough understanding of embodiments of the invention. Persons of ordinary skill in the art will recognize, however, that the invention can be practiced without one or more of the specific details. In other instances, well-known details are not shown or described to avoid obscuring aspects of the invention.

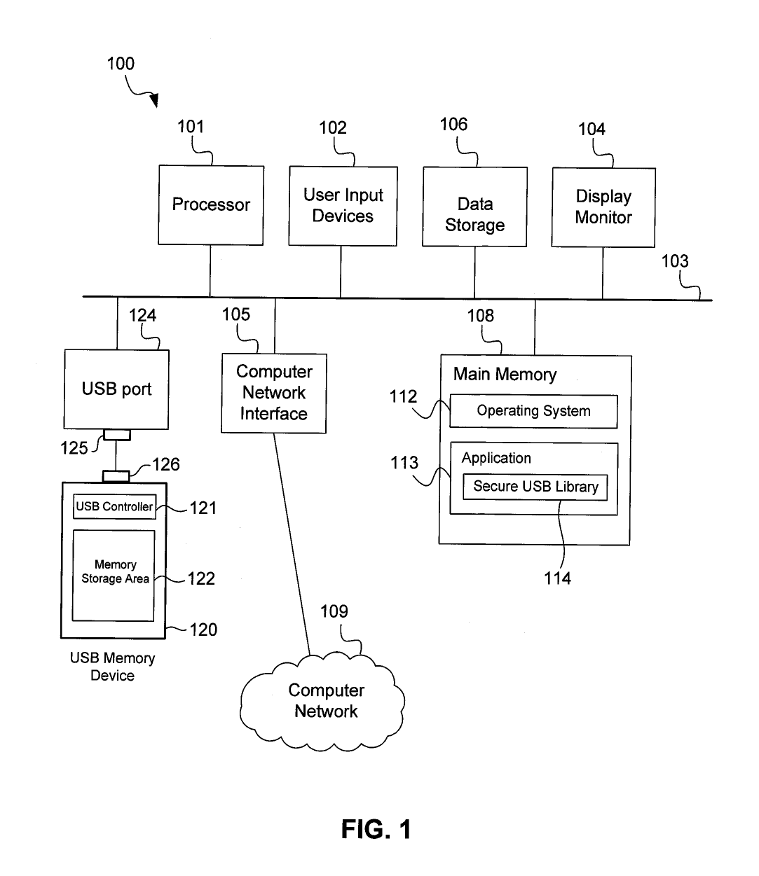

Referring now to FIG. 1, there is shown a schematic diagram of a computer 100 in accordance with an embodiment of the present invention. The computer 100 may have fewer or more components to meet the needs of a particular application. The computer 100 may include a processor 101. The computer 100 may have one or more buses 103 coupling its various components. The computer 100 may include one or more user input devices 102 (e.g., keyboard, mouse), one or more traditional rotating-disk data storage devices 106 (e.g., hard drive, optical disk), a display monitor 104 (e.g., liquid crystal display, flat panel monitor, cathode ray tube), a computer network interface 105 (e.g., network adapter, modem), and a main memory 108 (e.g., random access memory). The computer network interface 105 may be coupled to a computer network 109, which in this example includes the Internet.

In the example of FIG. 1, the computer 100 includes a universal serial bus (USB) port 124. A removable solid-state mass storage device in the form of a USB memory device 120 is connected to the USB port 124 for access by the processor 101 or other components of the computer 100. The USB memory device 120 is a “solid-state” device in that it does not have a rotating disk or other moving memory storage. It is to be noted that other types of removable mass storage devices (e.g., disk-based) may also be employed in other embodiments of the present invention. In one embodiment, the USB memory device 120 comprises a USB flash drive with a memory storage area 122 comprising flash memory. A USB controller 121 comprises electrical circuits for interfacing with the processor 101 or other components of the computer, and for controlling access to the memory storage area 122. The USB memory device 120 is removable in that it may be readily coupled and decoupled from the computer 100. To couple the USB memory device 120 to the computer 100, a connector 126 of the USB memory device 120 is pressed into a connector 125 of the USB port 124. The USB memory device 120 may be pulled from the USB port 124 to decouple the USB memory device 120 from the computer 100. The USB controller 121 receives commands from the computer 100 through the USB connector 126.

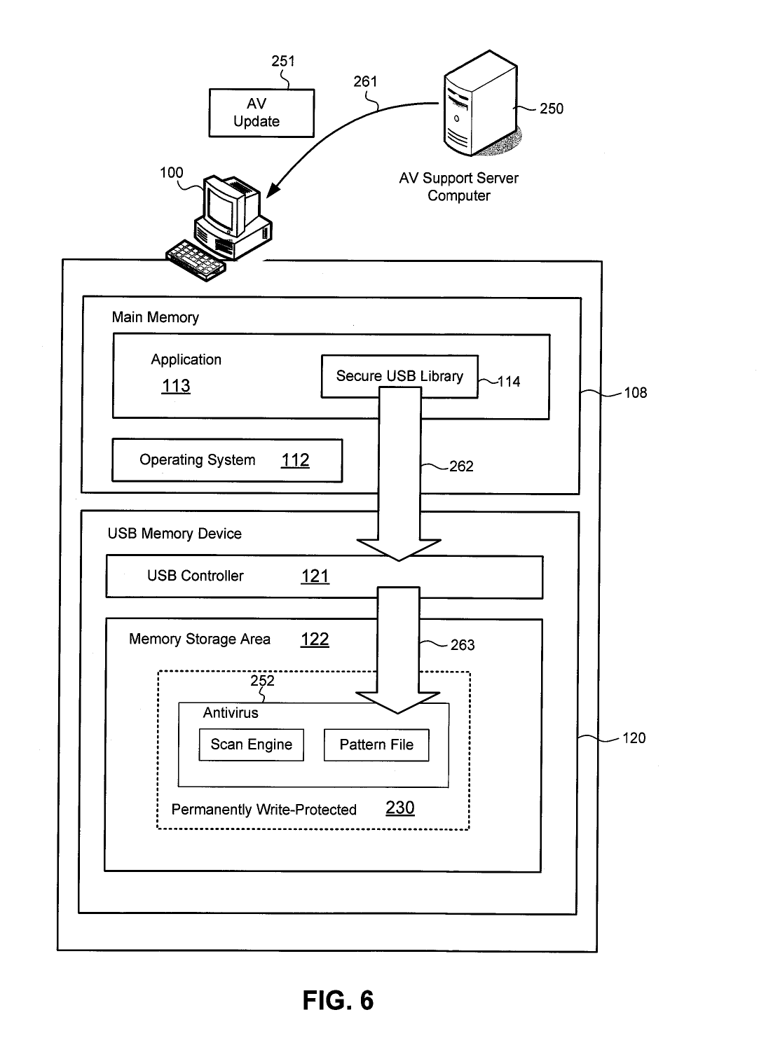

The computer 100 is a particular machine as programmed with computer-readable program code, which in the example of FIG. 1 includes an operating system 112 (e.g., Microsoft Windows™ operating system) and an application program 113 stored non-transitory in the main memory 108 for execution by the processor 101. The application program 113 may include a secure USB library 114, which may comprise application programming interfaces (APIs), functions, or procedures for communicating with the USB controller 121 to read from or write to the memory storage area 122 without employing an API or other program of the operating system 112 that is normally employed to access the memory storage area 122. In one embodiment, the application program 113 comprises an application program that works in conjunction with an antivirus program (e.g., see FIG. 6, antivirus program 252) or other computer security program (e.g., anti-spyware, etc.) that is stored in the USB memory device 120. For example, the application program 113 may be configured to provide updates to a scan engine or pattern file of the antivirus program. The computer 100 may also have other software components. The operating system 112, the application program 113, and other software components of the computer 100 may be loaded from the data storage device 106 to the main memory 108.

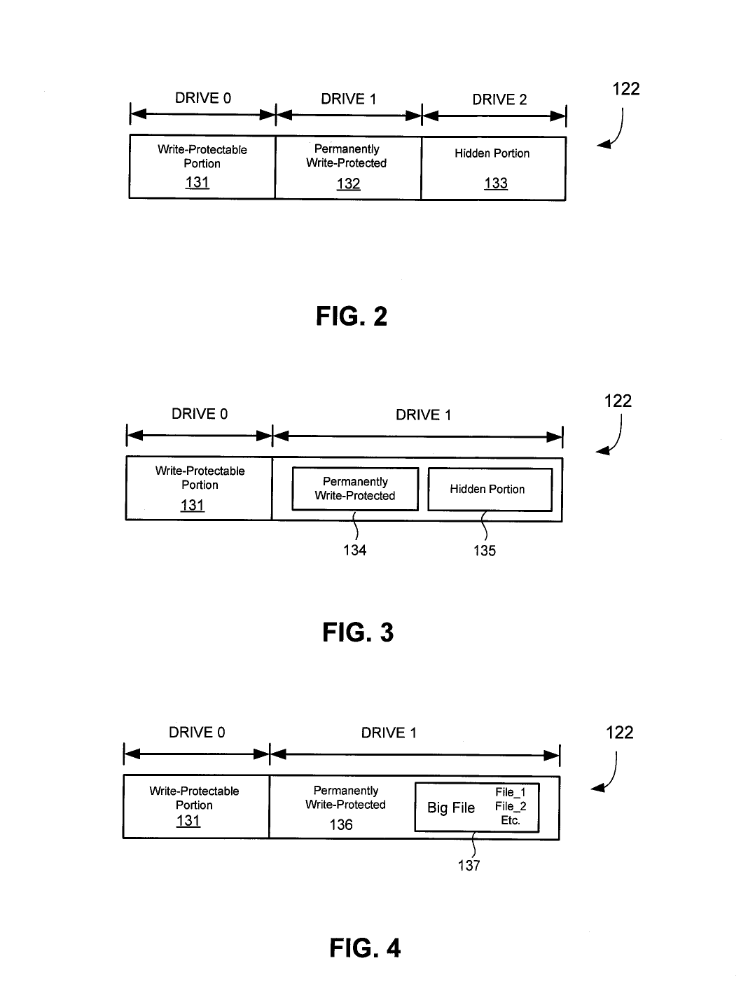

FIG. 2 schematically shows an example partition layout of the memory storage area 122 of the USB memory device 120 in accordance with an embodiment of the present invention. In the example of FIG. 2, the memory storage area 122 has been partitioned into three logical drives, namely, logical drive 0, logical drive 1, and logical drive 2. The logical drive 0 comprises a write-protectable portion 131 of the memory storage area 122, the logical drive 1 comprises a permanently write-protected portion 132 of the memory storage area 122, and the logical drive 3 comprises a hidden portion 133 of the memory storage area 122. The logical drives 0 and 1 each includes a file system of, and is thus visible to, the operating system 112. The logical drive 2, as well as the hidden portion 133 included therein, are not visible to and thus cannot be accessed, by the operating system 112. The operating system 112 does not recognize the hidden portion 133.

The write protectable portion 131 may have a conventional file system (e.g., file allocation table (FAT) file system) recognized by the operating system 112. As its name implies, the write protectable portion 131 comprises a portion of the memory storage area 122 that may be write-protected to prevent writing therein. The write-protection of the write-protectable portion 131 may also be disabled to allow writing. The write-protection of the write-protectable portion 131 may be disabled or enabled by the operating system 112 by sending appropriate commands to the USB controller 121. An application program may use an API of the operating system 112 to control the write protection of the write-protectable portion 131. In one embodiment, the write-protectable portion 131 is used by a computer security program or a component thereof as a temporary workspace. For example, the write-protectable portion 131 may be enabled for writing to allow writing to files stored therein, and then subsequently write-protected to prevent writing to the files.

The permanently write-protected portion 132 is a portion of the memory storage area 122 that is always in write-protection state. The permanently write-protected portion 132 may have a conventional file system recognized by the operating system 112. Although the operating system 112 can read files stored in the permanently write-protected portion 132, the operating system 112 cannot write or enable writing (i.e., disable write-protection) to the permanently write-protected portion 132. The USB controller 121 may be configured to enforce the permanent write-protection. The USB controller 121 may block any request to write or enable writing to the permanently write-protected portion 132, unless the request is from a security command available from the secure USB library 114 (but not from the operating system 112).

The USB controller 121 does not enforce permanent write-protection of the permanently write-protected portion 132 during manufacture of the USB memory device 120. During manufacture of the USB memory device 120, a conventional file system may be formatted in the permanently write-protected portion 132 and files of a computer security program may be stored in the permanently write-protected portion 132. After manufacture of the USB memory device 120, the USB controller 121 enforces the permanent write-protection to prevent unauthorized programs from modifying files (e.g., by writing) that are stored in the permanently write-protected portion 132. As will be more apparent below, one or more security commands provided by the secure USB library 114 may be employed to write to the permanently write-protected portion 132.

The hidden portion 133 of the logical drive 2 is not visible to or recognized by the operating system 112. For example, the operating system 112 cannot use a normal file system, such as the file allocation table (FAT) file system, to access the hidden portion 133. The memory storage area 122 may be pre-formatted in the factory so that the hidden portion 133 is not visible and accessible to programs that do not use predetermined security commands recognized by the USB controller 121 as valid commands for accessing the hidden portion 133.

In one embodiment, files in the hidden portion 133 can only be accessed using the secure USB library 114. The secure USB library 114 may include one or more security commands that are understood by the USB controller 121 for reading or writing data to the hidden portion 133. The security commands may be kept secret and proprietary to prevent unauthorized programs from making use of the security commands to access files in the hidden portion 133. The secure USB library 114 may include an API that makes use of the security commands to allow an authorized application program to access the hidden portion 132 to store, read, or modify files. The hidden portion 132 may have a file system (e.g., FAT32 file system) that is managed by a driver that works with the secure USB library 114 but not with the operating system 112. In one embodiment, the secure USB library 114 and its security commands are not available to unauthorized programs and the operating system 112. For example, the secure USB library 114 and its security commands may be made available only to an application program 113 that supports operations of a computer security program stored in the USB memory device 120.

In one embodiment, the portions 132 and 133 are secured portions of the memory storage area 122 in that security commands from the secure USB library are employed to write to the portions. In one embodiment, the USB controller 121 allows a write operation to the permanently write-protected portion 132 even when the permanently-write protected portion 132 is in write-protection state when the write operation is requested by a security command from the secure USB library 114. For example, the secure USB library 114 may include an API that issues a security command to the USB controller 121 to write, modify, or delete a file in the permanently write-protected portion 132. The USB controller 121 receives the security command and, in response, allows writing to the permanently write-protected portion 132 even when the permanently write-protected portion 132 is in write-protection state. However, when the operating system 112, or a component thereof, tries to write to the permanently write-protected portion 132 using a conventional access command (not a security command), the USB controller 121 responds that the permanently write-protected portion 132 is in write-protection state and blocks the attempt to write to the permanently write-protected portion 132.

FIG. 3 schematically shows an example partition layout of the memory storage area 122 of the USB memory device 120 in accordance with another embodiment of the present invention. In the example of FIG. 3, the memory storage area 122 has been partitioned into two logical drives, namely, logical drive 0 and logical drive 1. The logical drive 0 comprises a write-protectable portion 131 of the memory storage area 122, and the logical drive 1 comprises a permanently write-protected portion 134 and a hidden portion 135 of the memory storage area 122. The write-protectable portion 131 of the logical drive 0 is as previously described with reference to FIG. 2.

In the example of FIG. 3, the permanently write-protected portion 134 is essentially the same as the permanently write-protected portion 132 of FIG. 2. The main difference being that the permanently write-protected portion 132 is in the same logical drive as the hidden portion 135, whereas the permanently write-protected portion 132 and the hidden portion 133 of FIG. 2 are in separate logical drives. Like their counterparts in the example of FIG. 2, the permanently write-protected portion 134 and the hidden portion 135 are secured portions of the memory storage area 122

The permanently write-protected portion 134 may have a file system of the operating system 112 and is accessible by the operating system 112 in write-protection mode, i.e., read only. The USB controller 121 blocks any attempt to write to the permanently write-protected portion 134 without the corresponding security command. Because the operating system 112 does not have access to the security commands of the secure USB library 114, the operating system 112 can only perform read operations on files stored in the permanently write-protected portion 134. The hidden portion 135 is not visible to and cannot be accessed for reading, writing, or any other operation by the operating system 112. Like its counterpart in FIG. 2, the hidden portion 135 is only accessible by special security commands recognizable by the USB controller 121, such as APIs provided by the secure USB library 114.

It is to be noted that a solution similar to that provided by the partition layout of FIG. 3 may also be achieved, albeit with less security, using a conventional USB memory device that has only one logical drive without write-protection. In that case, a first portion of the memory storage area of the USB memory device is formatted for use by the operating system, and a second portion of the memory storage area is left unformatted. The second portion is used as a hidden portion that cannot be accessed by operating system file input/output operations, thereby preventing the operating system file manager (e.g., WINDOWS EXPLORER) from accessing the hidden potion.

Authorized programs, such as authorized antivirus software, may access the hidden portion using sector access APIs that are supported by the operating system. This solution is not as secure as others that use write protection, but still provides more security than conventional USB memory devices.

FIG. 4 schematically shows an example partition layout of the memory storage area 122 of the USB memory device 120 in accordance with yet another embodiment of the present invention. In the example of FIG. 4, the memory storage area 122 has been partitioned into two logical drives, namely, logical drive 0 and logical drive 1. The logical drive 0 comprises a write-protectable portion 131 of the memory storage area 122, and the logical drive 1 comprises a permanently write-protected portion 136 of the memory storage area 122. The write-protectable portion 131 of the logical drive 0 is as previously described with reference to FIG. 2. The memory storage area 122 does not have a hidden portion in the example of FIG. 4

In the example of FIG. 4, the permanently write-protected portion 136 operates in the same fashion as the permanently write-protected portion 132 of FIG. 2. Like the permanently write-protected portion 132 of FIG. 2, the permanently write-protected portion 136 is a secured portion of the memory storage area 122.

The permanently write-protected portion 136 may have a file system of the operating system 112 and is accessible by the operating system 112 in write-protection mode, i.e., read only. The USB controller 121 blocks any attempt to write to the permanently write-protected portion 136 without the corresponding security command. Because the operating system 112 does not have access to the security commands of the secure USB library 114, the operating system 112 can only perform read operations (and not write operations) on files stored in the permanently write-protected portion 136.

In the example of FIG. 4, the permanently write-protected portion 136 includes a single big file 137. The big file 137 may be an archive file that comprises a plurality of files. For example, the big file 137 may be used to manage a plurality of files in a manner similar to a zip file. Having a single big file 137 for managing a plurality of files reduces management cost for the file system. Depending on the application, the permanently write-protected portion 136 may also have more than one big file 137.

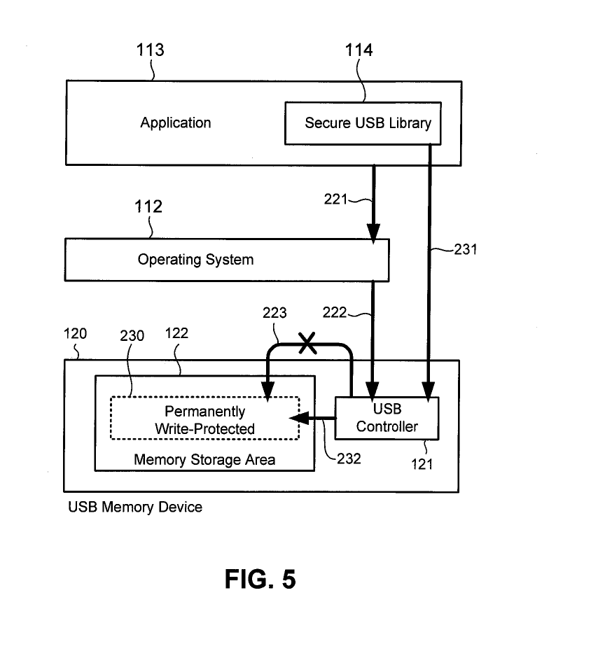

FIG. 5 shows a flow diagram schematically illustrating a method of accessing the memory storage area 122 of the USB memory device 120 in accordance with an embodiment of the present invention. In the example of FIG. 5, the application program 113 is compiled with or has access to the secure USB library 114. The Application program 113 may attempt to perform a write operation to a permanently write-protected portion 230 of the memory storage area 122 by way of the operating system 112, e.g., using an API or other program that comes with the operating system 112 for accessing the USB memory device 120 (see arrow 221). The write operation may be in the form of an access command to create a file or modify a file stored in the permanently write-protected portion 230, which is the same as a previously described permanently write-protected portion disclosed in FIGS. 2-4. The access command is received by the operating system 112, which sends the access command to the USB controller 121, e.g., by way of a driver of the operating system 112 for the USB memory device 120 (see arrow 222). Because the access command from the operating system 112 does not include the security command expected by the USB controller 121 for writing to the permanently write-protected portion 230, the USB controller 121 enforces the write-protection state of the permanently write-protected portion 230 and prevents the write operation to the permanently write-protected area 230 (see crossed arrow 223; the cross indicating the write operation is blocked).

To be able to write to the permanently write-protected portion 230, the application program 113 employs a security command provided by the secure USB library 114. The security command is not part of the library of programs provided by the operating system 112 for accessing the memory storage area 122. In one embodiment, only the secure USB library 114 includes the security command. As a particular example, the application program 113 may issue an API of the secure USB library 114 that includes the security command. The security command is specifically recognized by the USB controller 121 for writing to the permanently write-protected portion 230. The application program 113 issues the security command, which is received by the USB controller 121 (arrow 231). The USB controller 121 recognizes the security command as a valid command for writing to the permanently write-protected portion 230 and accordingly allows the writing operation to proceed even when the permanently write-protected portion 230 is still in write-protection state (see arrow 232). Because the security command does not use the API provided by the operating system 112 for accessing the memory storage area 122, the security command is not queued by the operating system 112, allowing the security command to advantageously bypass access prevention or access control mechanisms that may adversely impact the operation of computer security programs, for example

In the example of FIG. 5, the application program 113 employs a security command from the secure USB library 114 to write to the permanently write-protected portion 230. It should be noted that the procedure is similar when accessing a secured hidden portion of the memory storage area 122. In that case, the security command from the secure USB library 114 is for writing to or reading from the hidden portion. The USB controller 121 receives the security command (as in arrow 231) and performs the access request, either a read request or a write request, to the hidden portion per the security command (as in arrow 232). The application program 113 cannot perform the access to the hidden portion by way of the operating system 112 because the operating system 112 cannot even see the hidden portion.

FIG. 6 shows a flow diagram schematically illustrating a method of accessing the memory storage area 122 of the USB memory device 120 in accordance with another embodiment of the present invention. In the example of FIG. 6, the USB memory device 120 serves as a computer security device for scanning the computer 104 computer viruses. The USB memory device 120 includes an antivirus program 252, which comprises a scan engine and a pattern file stored in the permanently write-protected portion 230 of the memory storage area 122. The permanent write-protection advantageously prevents unauthorized programs from modifying the scan engine and the pattern file. The antivirus program 252 may employ a pattern matching algorithm to detect computer viruses. In one embodiment, the scan engine compares the contents of suspected files to computer virus signatures stored in the pattern file. The antivirus support server computer 250 may be operated by the vendor of the USB memory device 120 to periodically provide an antivirus update file 251 that comprises an updated pattern file or updated scan engine for detecting newly discovered computer viruses (see arrow 261). The computer 100 may receive the antivirus update file 251 over the Internet, for example.

The application program 113 may be configured to provide updates to computer security components of the USB memory device 120. In the computer 100, the application program 113 runs in the main memory 108 and receives the contents of the antivirus update file 251. Because the permanently write-protected portion 230 is in write-protection state, conventional APIs of the operating system 112 will not be able to perform a write operation in the permanently write-protected portion 230. Accordingly, the application program 113 employs the secure USB library 114, e.g., using an API of the secure USB library 114 that issues the security command, to send the security command to update the pattern file, scan engine, or both with an updated version from the antivirus update file 251 (see arrow 263). The USB controller 121 receives the security command, recognizes the security command as a valid command for performing write operations in the permanently write-protected portion 230, and accordingly updates the pattern file, scan engine, or both as per the security command while the write-protected portion 230 remains in write-protection state (see arrow 263). As can be appreciated, being able to access the permanently write-protected portion 230 without using an API or other program of the operating system 112 for doing so advantageously prevents other programs from tampering with the antivirus program 252 and advantageously allows access to the permanent write-protected portion 230 even when the operating system 112 is locking down access to the USB memory storage device 120 per its own security policies that conflict with the antivirus program 252.

While specific embodiments of the present invention have been provided, it is to be understood that these embodiments are for illustration purposes and not limiting. Many additional embodiments will be apparent to persons of ordinary skill in the art reading this disclosure.

What is claimed is:

1. A method of accessing a memory storage area of a removable mass storage device, the method comprising:
receiving an access command to perform a write operation to a write-protected portion of the memory storage area of the removable solid state mass storage device, the access command being from a program provided by an operating system of a computer to which the removable mass storage device is removably connected;
enforcing a write-protection state of the write-protected portion of the memory storage area by preventing the write operation of the access command from writing to the write-protected portion of the memory storage area;
receiving a security command to perform a write operation to the write-protected portion of the memory storage area, the security command not being from the program provided by the operating system;
recognizing the security command as a valid command for writing to the write-protected portion of the memory storage area; and
in response to recognizing the security command as the valid command for writing to the write-protected portion of the memory storage area, writing to the write protected portion of the memory storage area in accordance with the security command while the write-protected portion of the memory storage area remains in write-protection state.

2. The method of claim 1 wherein the method is performed by a universal serial bus (USB) controller and the removable mass storage device is a USB memory device.

3. The method of claim 1 further comprising:
updating a security program stored in the write-protected portion of the memory storage area while the write-protected portion of the memory storage area is in write-protection state.

4. The method of claim 3 wherein the security program comprises an antivirus program and the security command updates a pattern file of the security program stored in the write-protected portion of the memory storage area.

5. The method of claim 4 wherein the security command is only available to an application program that supports operations of the antivirus program.

6. The method of claim 1 wherein the security command is issued by way of an application programming interface (API) of a secure library not available to the operating system.

7. The method of claim 1 wherein the program provided by the operating system comprises an API of the operating system.

8. A removable mass storage device comprising:
a universal serial bus (USB) connector removably connected to a USB port of a computer;
a storage memory area; and
a USB controller that receives a command from the computer through the USB connector, prevents the command from writing to a secured portion of the storage memory area when the command is from a program provided by an operating system for accessing the storage memory area, and allows the command to write to the secured portion of the storage memory area in response to recognizing the command is a security command of a secure library not available to the operating system.

9. The device of claim 8 wherein the USB controller allows the security command to write to the secured portion of the memory storage area even when the secured portion of the memory storage area is in write-protection state.

10. The device of claim 8 wherein the secured portion of the memory storage area is a hidden portion not visible to the operating system.

11. The device of claim 8 wherein the secure library is available only to an application program that works in conjunction with a computer security program stored in the memory storage area.

12. The device of claim 11 wherein the computer security program comprises an antivirus program.

13. The device of claim 8 wherein the secured portion of the memory storage area is a permanently write-protected portion that is permanently in write-protection state.

14. A method of accessing a memory storage area of a removable mass storage device, the method comprising:
receiving an update for a computer security program stored in a write-protected portion of a memory storage area of a removable universal serial bus (USB) memory device;
sending a security command to a USB controller of the USB memory device to write to the write-protected portion of the memory storage area to update the computer security program while the write-protected portion of the memory storage area remains in write-protection state; and
updating the computer security program in the write-protected portion of the memory storage area in accordance with the update while the write-protected portion of the memory storage area remains in write-protection state.

15. The method of claim 14 wherein the write-protected portion of the memory storage area is permanently in write-protection state to prevent unauthorized programs from tampering with the computer security program.

16. The method of claim 14 wherein the computer security program comprises an antivirus program that is stored in the write-protected portion of the memory storage area.

17. The method of claim 16 wherein the update comprises an update to a pattern file of the antivirus program.

18. The method of claim 16 wherein the update comprises an update to a scan engine of the antivirus program.

19. The method of claim 14 wherein the update is received from a server computer over the Internet.

20. The method of claim 14 wherein sending the security command to the USB controller of the USB memory device comprises using an application programming interface (API) that issues the security command.
